(19) United States
(12) Patent Application Publication
(10) Pub. No.: US 2002/0092483 A1
(43) Pub. Date: Jul. 18, 2002

(54) Steam pressure reducing and conditioning system

(76) Inventor: Hiroyuki Higuchi, Kashiwazaki-shi (JP)

Correspondence Address: JENKENS & GILCHRIST, PC, 1445 ROSS AVENUE, SUITE 3200, DALLAS, TX, 75202, US

(21) Appl. No.: 10/039,343

(22) Filed: Jan. 4, 2002

(30) Foreign Application Priority Data
Nov. 30, 2000 (JP) 2000/366138

(51) Int. Cl. F22G 3/00; F28B 1/00; F22G 1/00; F02M 1/00; F22D 5/26

(52) U.S. Cl. 122/459; 122/451.2; 122/452

(57) ABSTRACT

A steam conditioning system comprising a steam conditioning valve 1 for depressurizing and desuperheating steam S by supplying moisture W in said conditioning valve. A discharge pipe 3 connected to the steam conditioning valve 1 has a horizontal section 3a, and said horizontal arrangement section 3a is provided with a moisture drain 4 or at a portion near the bottom. Condensed moisture W₁ is extracted from this moisture drain 4 and is recycled as moisture W to be supplied to the steam S in said conditioning valve 1. The steam conditioning valve 1 further has a reduced annular section 9 with a nozzle 5a disposed therein for injecting subcooled water mist W. A transport conduit 5 connects the drain 4 to nozzle 5a. Moisture W is drawn into steam flow S due to the Venturi effect caused by the pressure drop through the reduced annular section 9.

### TECHNICAL FIELD OF THE INVENTION

The present invention concerns a steam pressure reducing and conditioning system.

### RELATED APPLICATION

The present invention includes common subject matter disclosed in U.S. application Ser. No. ______ [to be assigned], entitled Steam Pressure Reducing and Conditioning Valve by the same inventor Hiroyuki Higuchi filed concurrently on ______, under attorney docket number 52643-00351USPT, the disclosure of which is incorporated herein by reference.

### BACKGROUND OF THE INVENTION

Referring to Prior Art FIG. 3, it has been known to have a steam pressure reducing and conditioning system comprising a steam source 24 (such as boiler) for generating superheated steam S, a pressure reducing and conditioning valve 21 for depressurizing and desuperheating steam S generated by this steam source 24, and a discharge pipe 23 connected to an outlet of steam pressure reducing and conditioning valve 21, and connected to a steam work section 22, downstream of valve 21.

As illustrated in Prior Art FIG. 3, steam pressure and conditioning valve 21 receives superheated and pressurized steam S inflowing in inlet 21a. Steam S is desuperheated and depressurized by passing steam S valve 21 and injecting subcooled water mist W from one or more nozzles 25 in the lower portion of valve 21.

The desuperheated and depressurized steam S₁, discharged from the valve 21 and the subcooled water mist W injected in valve 21, flow into the discharge pipe 23 and are conveyed to the steam work section 22. A portion of discharge pipe 23 is arranged horizontally 23a. Some of the subcooled water mist W condenses and clings to the discharge pipe at 23a and flows along the bottom of the horizontal section. Steam S₁ flows past these areas of condensation creating temperature differentials in the interior surface of the pipe 23.

Consequently, the pipe 23 deforms (bends upward) and possibly breaks due to expansion and stress due to the temperature difference in horizontal section of pipe 23, and moreover, the condensed moisture W₁, flowing at the bottom of the pipe 23 is enrolled up by the high speed flow of steam S₁ (jumping phenomenon). The jumping phenomenon erroneous temperature measurements in temperature sensors in the pipe 23 for detecting the heat of the steam S₁.

It is an object of the present invention to provide a steam pressure reducing and conditioning system that can solve the aforementioned problems.

### BRIEF DESCRIPTION OF THE DRAWINGS

The disclosed invention will be described with reference to the accompanying drawings, which show important sample embodiments of the invention and which are incorporated in the specification hereof by reference. A more complete understanding of the present invention may be had by reference to the following Detailed Description when taken in conjunction with the accompanying drawings, wherein:

FIG. 1 is a partial side view with schematic elements illustrating the operation of the steam pressure reducing and conditioning system of the present invention;

FIG. 2 is a partial cross-section view illustrating a portion of the pressure reducing and conditioning valve used in the system of the present invention of FIG. 1; and

FIG. 3 is a partial side view with schematic elements illustrating the operation of a prior art steam pressure reducing and conditioning system.

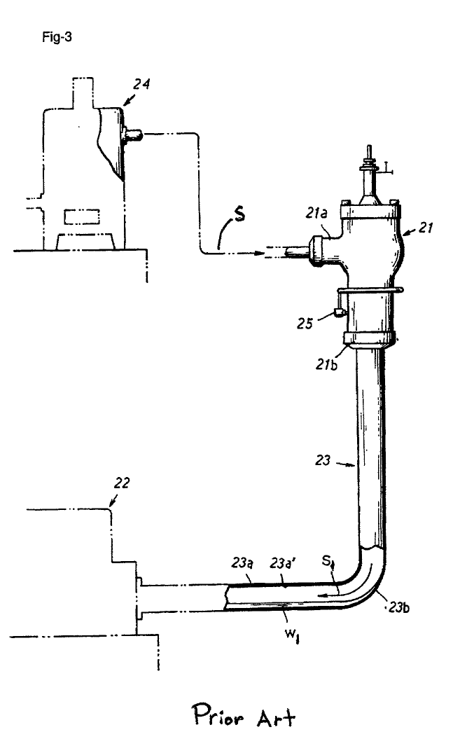

### SUMMARY OF THE INVENTION

Reference is now made to the Drawings wherein like reference characters denote like or similar parts throughout the Figures.

The present invention concerns a steam pressure reducing and conditioning system comprising a steam reducing and conditioning valve 1 for desuperheating and depressurizing superheated steam S by injecting subcooled water mist W in the lower portion of valve 1. A discharge pipe 3 is connected at its proximal end to the exit of valve 1. A steam work section 2 is connected at the distal end of pipe 3. The discharge pipe 3 has a horizontal portion 3a, and said horizontal portion 3a is provided with a moisture drain 4 at the bottom portion or at a portion near the bottom of the horizontal portion 3a of pipe 3. Condensed subcooled water mist (“moisture”) W₁ is extracted from discharge pipe 23 by drain 4 and is recycled and reinjected as moisture W to be supplied to the vapor S in said conditioning valve 1. Moisture drain 4 is connected by a moisture transport conduit 5 to the conditioning valve 1.

The steam conditioning valve 1 further includes a reduced annular section 9 with a nozzle 5a disposed therein for injecting subcooled water mist W into the reduced annular section 9 of conditioning valve 1. Moisture W is drawn into steam flow S due to the Venturi effect caused by the pressure drop through the reduced annular section.

Method of Operation

A superheated steam S is desuperheated by supplying subcooled water mist (“moisture”) W to steam conditioning valve 1. The desuperheated steam S₁ flowing out from the conditioning valve 1 and the moisture W used for cooling in discharge valve 1 flows into discharge pipe 3, and is introduced in the steam work section 2 connected to the downstream area of the discharge pipe 3.

In the present invention, when the moisture W discharged from the conditioning valve 1 flows through the horizontal section 3a of the discharge pipe 3, the condensed moisture W₁ is drained from a moisture drain 4 disposed at the bottom portion 3a of this pipe 3, and the moisture W₁ extracted from the moisture drain 4 is recycled as part of moisture W to be supplied to the steam S in the steam conditioning valve 1.

Consequently, moisture W₁ can be removed from the horizontal section 3a of the pipe 3, preventing the moisture W₁ from stagnating at the bottom of the pipe, solving the aforementioned problem of the prior art discussed in the background section, and further, the recycling of moisture W₁ used for cooling the vapor S again in the conditioning valve 1 saves energy.

### DETAILED DESCRIPTION

The attached drawings show an embodiment of the present invention, which will be described below.

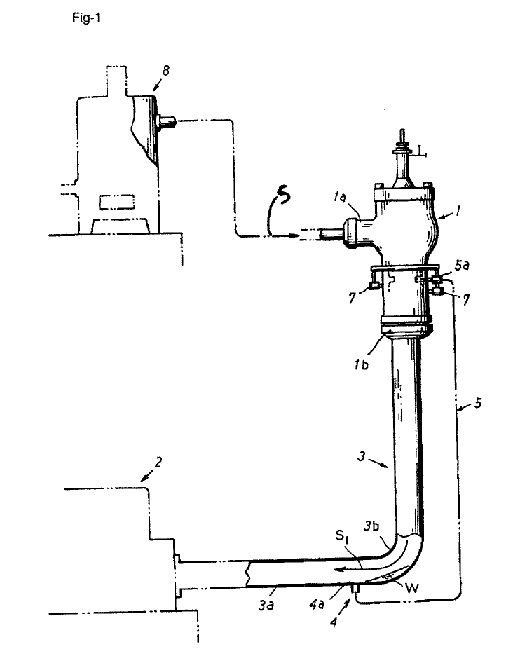

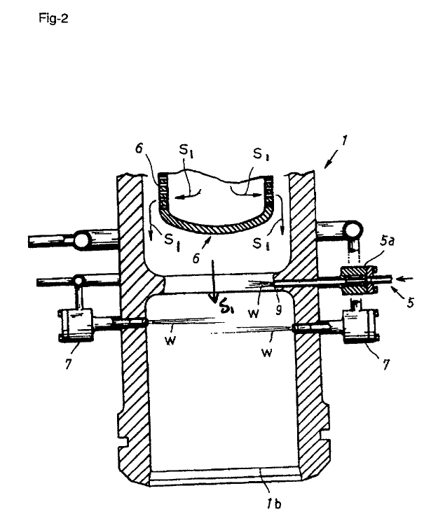

This embodiment of the present invention comprises, as shown in FIGS. 1 and 2, a steam desuperheating and conditioning valve 1 wherein a superheated and pressurized steam S generated in a steam generation source 8 (for instance, boiler) flows into a first port 1a of conditioning valve 1. Steam S is desuperheated and depressurized by passing through a small hole section 6 (diffuser) having scattered small holes 6a, and the steam S₁ is discharged from a second port 1b of conditioning valve 1. Steam S₁ is desuperheated by injecting a subcooled water mist “moisture” W from one or more nozzles 7. A discharge pipe 3 is connected at its proximal end to the exit of conditioning valve 1, and at its distal end to a steam work section 2 (for instance, condenser for a nuclear reactor).

Also, in this embodiment, the discharge pipe 3 is provided with a horizontal section 3a extending from the conditioning valve 1 and disposed horizontally with an elbow section 3b (bent section). The discharge pipe 3 is so composed that the condensed moisture W₁ flowing in this horizontal section 3a is part of the moisture W to be supplied to the vapor S in the conditioning valve 1.

To be more specific, as shown in FIG. 1, said discharge pipe 3 is provided with a moisture drain 4 having a drain hole 4a at or near the bottom portion of the horizontal section 3a, said moisture drain 4 is provided with a moisture transport conduit 5 for conveying moisture W₁ extracted from the moisture drain 4 to the vapor cooler 1.

This moisture transport conduit 5 is a tubular element having a predetermined diameter, and connected to a reduced annular area 9 constituting a predetermined area of the conditioning valve 1, where a steam S₁ flowing in the conduit will flow faster than the steam flowing in the larger diameter discharge pipe 3.

Referring to FIG. 2, an annular reduced diameter section 9 is disposed in the lower portion of conditioning valve 1 at a position near the jet nozzle 7 of the conditioning valve 1. A nozzle 5a of the moisture conduit 5 exits into this reduced diameter section 9, and it is so configured that the moisture W₁ in the moisture conduit 5 is injected into depressurized steam S₁ path, in this reduced diameter section 9.

This reduced diameter section 9 obtains improved cooling effect by maintaining the steam S₁ flow rate immediately passing through the reduced diameter section 9 faster than the vapor S₁ passing through the discharge pipe 3, thereby reducing the pressure at the position of the reduced diameter section 9 below the pressure in the discharge pipe 3. This pressure drop in a reduced diameter section 9 is due to the increased velocity of a constant flow volume. Such an effect is well known in the art and is referred to as a Venturi effect. Consequently, this embodiment of the present invention allows return of the moisture W₁ from the discharge pipe 3 to the conditioning valve 1 by connecting the nozzle 5a of moisture transport conduit 5 to this reduced diameter section 9, and drawing the moisture W₁ from the nozzle 5a into the conditioning valve 1 using the differential pressure generated by the Venturi negative pressure phenomenon.

Considering the optimal conditions for the circulation method using this differential pressure, it is preferable to set this level difference to 10 meters or less, in the case where the moisture drain 4 is placed lower than the nozzle 5a (no limitation in the case where the moisture drain section 4 is placed higher than the nozzle 5a).

In this embodiment, the vapor S₁ differential pressure is used as mentioned before, as a means for recycling the moisture W₁ flowing from the conditioning valve 1 back to the conditioning valve 1. The system also permits connecting the moisture transport conduit 5 to a desired position of the conditioning valve 1 by disposing a forced delivery apparatus (for instance a pump or the like), in the middle section of the moisture transport conduit 5.

Composed as described above, this embodiment desuperheats the steam S in the conditioning valve 1, and the desuperheated and depressurized steam S₁ is discharged from the conditioning valve 1 together with moisture W into the discharge pipe 3. The steam S₁ flowing through discharge pipe 3 is introduced into the steam work section 2 connected to the distal end of the discharge pipe 3. The moisture W₁ flowing at the bottom of the discharge pipe 3 is extracted by the moisture drain 4, transferred by the moisture transport conduit 5 and recycled as moisture W for cooling in the steam conditioning valve 1.

Therefore, this embodiment provides for an energy efficient removal of the moisture W₁ from the horizontal section 3a of the discharge pipe 3, thereby preventing the moisture W₁ from stagnating at the bottom of the discharge pipe 3, avoiding as much as possible the pipe 3 deformation (damage) and the detrimental effect to the temperature detection sensor and other problems of the prior art. Additionally, the present invention provides for recycling the moisture W₁ used for cooling the vapor S₁ in the conditioning valve 1 providing for energy efficient cooling.

I claim:

1. A steam conditioning system having:
a steam conditioning valve for depressurizing and desuperheating superheated steam by supplying moisture thereto;
a discharge pipe connected to a discharge end of the steam conditioning valve, wherein the improvement comprises:
a horizontal section of the discharge piping being provided with a moisture drain in proximity to the bottom of the horizontal section of the discharge pipe;
a nozzle for injecting a water mist into a lower portion of the discharge valve; and a conduit for connecting said nozzle to said drain for transporting condensed water to said nozzle.

2. The steam conditioning system of claim 1 wherein the nozzle has an opening exiting into an annular reduction in the longitudinal cross-section of the lower portion of said valve, wherein moisture is drawn from the drain through the transport conduit and out the exit nozzle into the conditioning valve due to Venturi effect.
